(19) United States
(12) Patent Application Publication
(10) Pub. No.: US 2014/0118206 A1
(43) Pub. Date: May 1, 2014

(54) ANTENNA AND FILTER STRUCTURES

(71) Applicant: MESAPLEXX PTY LTD, Eight Mile Plains (AU)

(72) Inventors: David Robert HENDRY, Brisbane (AU); Steven John COOPER, Brisbane (AU); Peter Blakeborough KENINGTON, Chepstow (GB)

(73) Assignee: MESAPLEXX PTY LTD, Eight Mile Plains (AU)

(21) Appl. No.: 13/660,673

(22) Filed: Oct. 25, 2012

(51) Int. Cl. H01Q 13/18

(52) U.S. Cl. 343/767

(57) ABSTRACT

A combined filter and antenna structure comprising a multi-mode cavity filter and an antenna, wherein: the filter comprises: a dielectric body provided with a conductive covering; and an interface arranged to exchange energy between a standing wave in the body and a current conveyed external to the body; and the antenna is arranged to exchange energy between a travelling wave outside the body and a standing wave inside the body and the antenna comprises: a first window provided in the covering.

### FIELD OF THE INVENTION

The invention relates to filters and antennas for processing electrical signals.

### BACKGROUND

Single mode dielectric filters are in widespread use in many communications systems, including both low and high-power use within the cellular communications industry. In particular, duplex filters, used in many handsets, will typically employ this form of filter technology and some higher power applications exist, although the high losses associated with commercial products typically restrict their use to power levels of a few watts (mean power) or less.

In order to achieve a steep roll-off and a wide pass-band bandwidth in a dielectric filter design, it is typically necessary to cascade a number of dielectric resonators in series. This process will typically result in a significant increase in the loss in the (wanted) pass-band, due to both the insertion loss of the dielectric material itself (i.e. the dielectric losses within that material) and the coupling losses in transferring energy into and out of the dielectric.

Interest in the use of multi-mode filters is growing, since these filters allow a piece of dielectric material (or ‘puck’) to be, effectively, re-used multiple times, to form a more complex filter characteristic. This will have, typically, a steeper roll-off and a wider pass-band bandwidth than an equivalent single-mode resonator could achieve. It will also, typically, result in lower losses, due to the reduction in the number of times the signal needs to be coupled into and out of the dielectric material. A typical example would be a triple mode filter, in which the dielectric material is excited in three dimensions or ‘planes’—the X-plane, the Y-plane and the Z-plane. The excitation can be in the form of H-field (magnetic) or E-field (electric) or a combination of the two (in any ratio). A triple-mode resonance in a cubic body 100 is shown in FIGS. 1A to 1C, each of which shows a different one of the modes. In these drawings, the E-field is shown by solid arrows (pointing into the plane of the paper in the case of FIG. 1A) and the H-field is denoted by dotted lines in loops around the E-field lines.

The structure shown in FIGS. 1A to 1C is that of a cavity filter. This is a widely-used and inherently low loss structure, due to the greater metal area contacting the dielectric and ‘reflecting’ the fields set up within the dielectric—this greater metal area reduces the I²R losses in the metal. In contrast, a transmission line filter (e.g. a comb line or inter-digital filter) generally concentrates current in a relatively small conductor and hence has generally higher losses.

Cavity filters typically have the drawback of being large and heavy, however using a multi-mode approach allows the filter's dielectric to be used multiple times (in effect) and hence allows the filter to be more compact for a given number of poles and zeros in its response. A triple mode filter, for example, can have up to three poles and three zeros per resonator, whereas a conventional single cavity filter will only have a maximum of one pole and one zero and hence will require three times the number of resonators to achieve the same filter characteristic.

The result of using a multi-mode approach is a filter (or resonator) which has, in principle, a low cost structure, a low loss and a small size. This is highly beneficial in active antenna applications where many filters are required in each active antenna product—for example, up to 16 would typically be required in a 16-element 900 MHz active antenna product. Unless small, low-cost, low-loss filters are used, the product becomes either too heavy or too expensive to be deployed on a large scale.

An active antenna system also contains antenna elements to radiate and receive signals. These antenna elements act in unison to form a single beam or multiple beams, depending upon the phase relationship or phase and amplitude relationship of the signal or signals feeding them. Such systems are well known in the art and will not be described in detail here.

Whilst a multi-mode filter used in an active antenna architecture can bring significant benefits, it is possible to improve such systems still further. The duplex filter typically specified for such systems typically has a direct connection to an antenna element designed to radiate and receive the desired radio signals. This connection, despite its short length, will incur losses, both due to mismatches of the various impedances involved (such mismatches are not caused by design, but result from imperfections in the manufacturing processes of the various components and materials involved) and due to the non-zero resistance of the conductors used. For example, there will be a mismatch between the coupling structure used on the puck (i.e. a conductive interface on the puck for passing signals into and/or out of the puck) and the PCB upon which the puck is mounted, together with losses in the PCB tracks; there will also be losses in connecting this PCB to the PCB upon which the antenna element is formed (if it is a patch antenna) or the coaxial (or other transmission line) connection to a formed metal antenna structure (e.g. a dipole). Even the radiating element itself will have a non-zero resistivity and hence some loss. Each of these losses, individually, will be very small, but taken together, they will have an appreciable impact upon the overall antenna's EIRP (effective isotropic radiated power) and its receive noise figure.

FIG. 2 shows a typical schematic for the connection of two filters 210 and 212, forming a duplexer 214, and an antenna element 216 in, for example, an active antenna system. As can be seen from this figure, a number of transmission lines are required, together with transitions from, for example, the filters 210 and 212 (e.g. dielectric resonators) to their associated transmission lines 218, 220 and 222. These transitions will, inevitably, incur some small mismatch losses and the transmission lines 218, 220 and 222 themselves will also incur losses, due to their finite resistivity. Likewise, the transition from the final transmission line 222 to the antenna element 216 will also incur some mismatch-related losses. Finally, the antenna element 216 itself will have a non-zero resistivity and consequently will introduce a loss. Individually, these losses will be small, but taken together, the total will typically be in the range of 1 to 2 dB, depending upon the technologies chosen for the various elements and the frequencies involved. These losses will degrade both transmit EIRP and receive sensitivity (noise figure) of an antenna system and reduce its coverage area.

### SUMMARY OF THE INVENTION

According to one aspect, an embodiment of the invention provides a combined filter and antenna structure comprising a multi-mode cavity filter and an antenna. The filter comprises a dielectric body provided with a conductive covering and an interface arranged to exchange energy between a standing wave in the body and a current conveyed external to the body. The antenna is arranged to exchange energy between a travelling wave outside the body and a standing wave inside the body. The antenna comprises a first window provided in the covering. Structures formed in this way can compactly combine filtering and antenna operations.

In some embodiments, the interface may comprise a second window provided in the covering and a contact of conductive material connected to the body in the second window. The contact may be a patch of conductive material provided on the body in the second window. Such a patch may extend to an edge of the second window and be electrically connected to the covering. The contact may be a conductive probe penetrating into the body in the second window.

The first window may be a straight slot in the covering. The slot may be parallel or perpendicular to a current flow that corresponds to a standing wave that will be established in the body when the structure is in use.

In some embodiments, the first window may be cruciform in the manner of first and second intersecting straight slots. The first slot may run perpendicular to the second slot. The first and second slots may be parallel with, respectively a first standing wave and a second standing wave that will be established in the body when the structure is in use.

The interface may comprise a second window provided in the covering, a first conductive track on the body in the second window and a second conductive track on the body in the second window, with the first and second tracks configured to preferentially couple to the first and second standing waves, respectively.

In some embodiments, the antenna may comprises an island of conductive material on the body in the first window.

In some embodiments, the interface may comprise a second window provided in the covering and a contact of conductive material connected to the body in the second window, with the antenna further comprising a ground plane separated from the island with the ground plane positioned to at least partially cover the second window.

In some embodiments, the covering is a coating on the body.

In some embodiments, the first and second windows are parallel with one another.

### BRIEF DESCRIPTION OF THE DRAWINGS

By way of example only, various embodiments of the invention will now be described by reference to the accompanying drawings, in which:

FIGS. 1A to 1C schematically illustrate different electromagnetic standing waves modes within a cubic body;

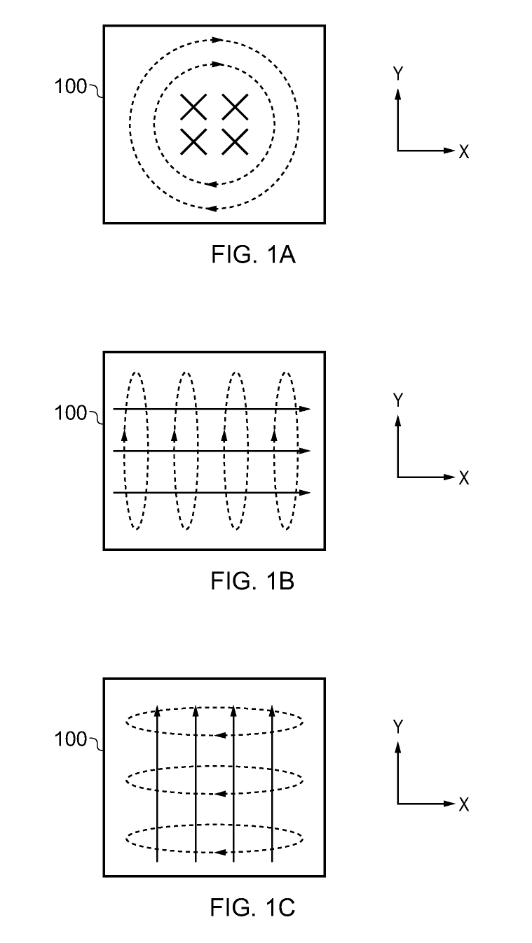

FIG. 2 schematically illustrates an arrangement for connecting transmit and receive filters to an antenna in an active antenna system;

FIG. 3 schematically illustrates a multi-mode cavity filter based on a dielectric puck;

FIG. 4 schematically illustrates a combined filter element and radiating structure, utilising a multi-mode excitation coupling structure and an ‘open window’ radiating structure;

FIG. 5 schematically illustrates a combined filter element and radiating structure, utilising a multi-mode excitation coupling structure and a patch antenna as the radiating structure;

FIG. 6 schematically illustrates the use of patch elements, in a combined filter element and radiating structure, for both exciting the modes within the resonator and as a radiating element (‘antenna’) to radiate the filtered output signals into free space;

FIG. 7 schematically illustrates using two combined filter element and radiating structures to form a duplexer;

FIG. 8 schematically illustrates using four combined filter element and radiating structures to form a duplexer with cross-polar antenna capabilities;

FIG. 9 schematically illustrates a combined filter element and radiating structure, utilising a multi-mode excitation coupling structure and a slot in the metallisation as the radiating structure;

FIG. 10 schematically illustrates a combined filter element and radiating structure, utilising a multi-mode excitation coupling structure and a cruciform opening in the metallisation as the radiating structure;

FIG. 11 schematically illustrates a combined filter element and radiating structure, utilising a multi-mode excitation coupling structure and a cruciform opening in the metallisation as the radiating structure, in which the cruciform is not aligned to the vertices of the face upon which it is placed;

FIG. 12 schematically illustrates a dual-polarisation filter/radiating subsystem incorporating individual mode excitation for each polarisation and a cruciform radiating structure; and

FIG. 13 schematically illustrates a transmitter utilising multi-mode filters together with a dual-polarisation filter/radiating subsystem incorporating individual mode excitation for each polarisation and a cruciform radiating structure.

### DETAILED DESCRIPTION

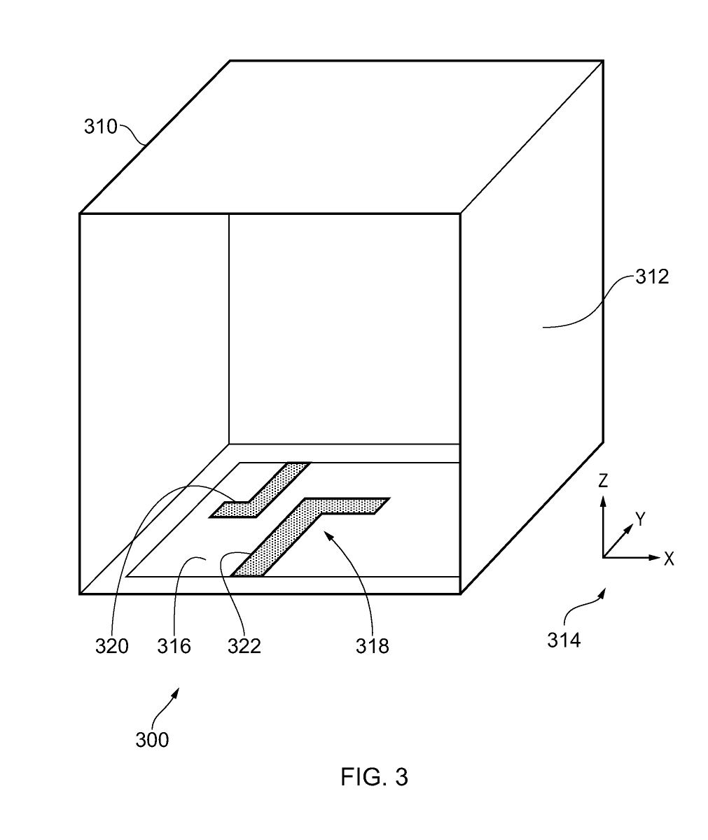

FIG. 3 shows a type of multi-mode filter. The filter 300 shown in FIG. 3 comprises a cubic puck 310 of ceramic dielectric with an applied metallisation 312. In FIG. 3, the metallisation on the nearest face of the puck and the puck itself have been shown as transparent so that various features pertaining to the metallisation can be seen and therefore described more easily. For the avoidance of doubt, however, the metallisation 312 extends completely over the nearest face of the puck and is continuous with the metallisation on the adjacent faces of the puck. This concept of treating the puck 310 and the metallisation 312 as transparent will be extended to FIGS. 3 to 11.

Given that the puck 310 is a cube, standing waves can be established in the puck in three distinct orientations. In each orientation, the electric field vector of the standing wave is parallel to the an edge of the cubic puck 310. The edges of the puck 310 can be thought of as running in orthogonal X, Y and Z directions, as indicated by Cartesian axes 314 in FIG. 3. Thus, it is a useful simplification to refer to the standing wave modes in the puck 310 as being X, Y or Z mode when their electric field vectors lie parallel to the X, Y and Z axes, respectively.

A window 316 is formed in the metallisation 312 on one face (in this case, the bottom face) of the cube, exposing the surface of the puck. Beyond the window 316, the metallisation 312 is continuous over the exterior of the puck 310. On the surface of the puck 310, in the window 316, is provided a coupling structure 318. The coupling structure 318 is a group of metal tracks, in this case two tracks 320 and 322, laid out in the window 316. An electrical signal is applied to the puck 310 through one of the tracks 320 in order to excite standing waves in multiple different modes within the puck 310. The other track 322 couples the signal out of the standing waves so that it can be conveyed to other circuitry (not shown).

In passing through track 320, into the puck 310, through the puck 310 and out of the puck 310 through track 322, an electrical signal will undergo filtering. The characteristics of this filtering are determined in part by the shape that is given to track 320, since that shape determines the extent to which the energy of an applied signal is coupled into the different standing wave modes in the puck 310. Likewise, the characteristics of this filtering are determined in part by the shape that is given to track 322, since that shape determines the extent to which the energy of the extracted signal is drawn from the different standing wave modes in the puck 322. Moreover, the characteristics of this filtering are determined in part by the shape of the puck 310, since that shape determines the characteristics of the standing waves that are set up within the puck 310.

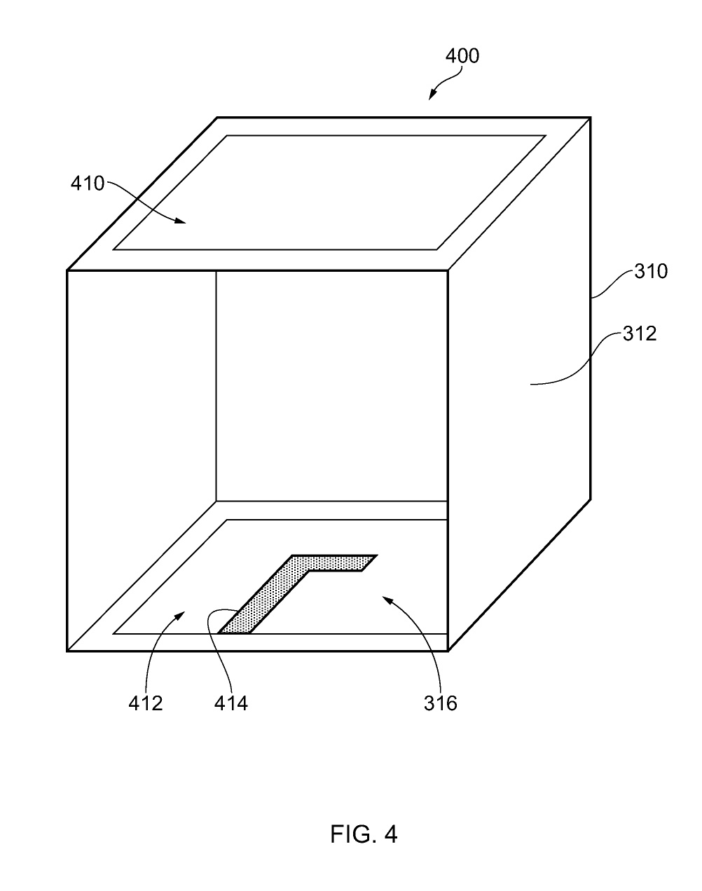

FIG. 4 shows a structure 400 that is a development of the type of multi-mode filter 300 that is shown in FIG. 3. In fact, in FIG. 4, elements that are carried over from FIG. 3 retain the same reference numerals and, in the interests of brevity, their nature and function will not be described again here. The same statement applies to all of the remaining drawings, to the extent that they reuse reference signs from earlier drawings. The structure 400 shown in FIG. 4 acts as both a filter and an antenna and hereinafter such a structure shall be referred to as a “Filtenna”.

In essence, the Filtenna 400 shown in FIG. 4 differs from the filter 300 shown in FIG. 3 in that a further window 410 is formed in the metallisation 312, on another surface of the cubic puck 310 (in the case shown, the top face) and the coupling structure 412 serves a slightly different purpose. The Filtenna 400 can serve in a transmitting role or in a receiving role, as will now be discussed.

In the transmitting role, a signal is coupled into the puck 310 through the coupling structure 412 and into standing wave modes within the puck 310. The second window 410 allows the electromagnetic energy contained within the puck 310 to radiate out of the puck 310 into free space, thereby forming a type of dielectric-loaded antenna. However, the signal that radiates from this antenna is a modified version of the signal that is fed in through the coupling structure 412—a version that has been modified by the filtering arising from the configuration of the track or tracks in the coupling structure 412 and the characteristics of the puck 310. Thus, in the transmitting role, the Filtenna 400 filters and then radiates a signal that is applied to the coupling structure 412. In the receiving role, travelling waves enter the puck 310 through the antenna window 410 and couple energy into the standing wave modes within the puck 310. Some of the energy within the standing waves is coupled out of the puck 310 by the coupling structure 412 as an electrical signal that is then conveyed to other circuitry (not shown). Thus, in the receiving role, the Filtenna 400 captures and then filters a wireless signal that arrives at the window 410. In much of the discussion that follows, the operation of Filtennas will, for the sake of brevity, be discussed primarily from the standpoint of the transmitting role, although operation “in reverse” in the receiving role will be appreciated by the skilled person (and in any case is often noted in parentheses).

The specific design shown in FIG. 4 is, of course, just an example. The puck 310 need not be cubic in shape. The puck 310 could be made of a dielectric material other than a ceramic. The antenna window 410 does not necessarily have the same dimensions or shape as the window 316 that accommodates the coupling structure 412. In the case shown, the coupling structure 412 is a metal track 414 laid out on the puck and extending along a two-dimensional path so that the coupling structure 412 is capable of simultaneously exciting multiple standing wave modes within the puck 310. However, the track 414 could have a simpler layout, or could even be replaced with an isolated patch (or, indeed, a conductive probe protruding, needle-like into the puck 310), in which case the coupling of energy into multiple standing wave modes could be achieved by designing irregularities into the puck 310, altering it from a pure cubic shape. The skilled person will realise that this list of variations is by no means exhaustive.

The Filtenna 400 eliminates losses between the filtering element and the radiating element (e.g. arising from an interconnecting transmission line) and therefore can be much more efficient than the traditional approach of using separate antenna and filtering elements. In addition, the size of the puck 310 can be much smaller than that of a traditional radiating element, since the dielectric loading of the system results in a small radiating structure; this is also a significant benefit, since it will save both size and weight on a traditional cell-tower, for example, and thereby allow a larger number of antennas to be deployed at a given site. The greater coverage afforded by this system, due to its lower radiating losses and improved receive sensitivity, could also lead to a reduction in the number of cell sites required in a given network (thereby saving further cost).

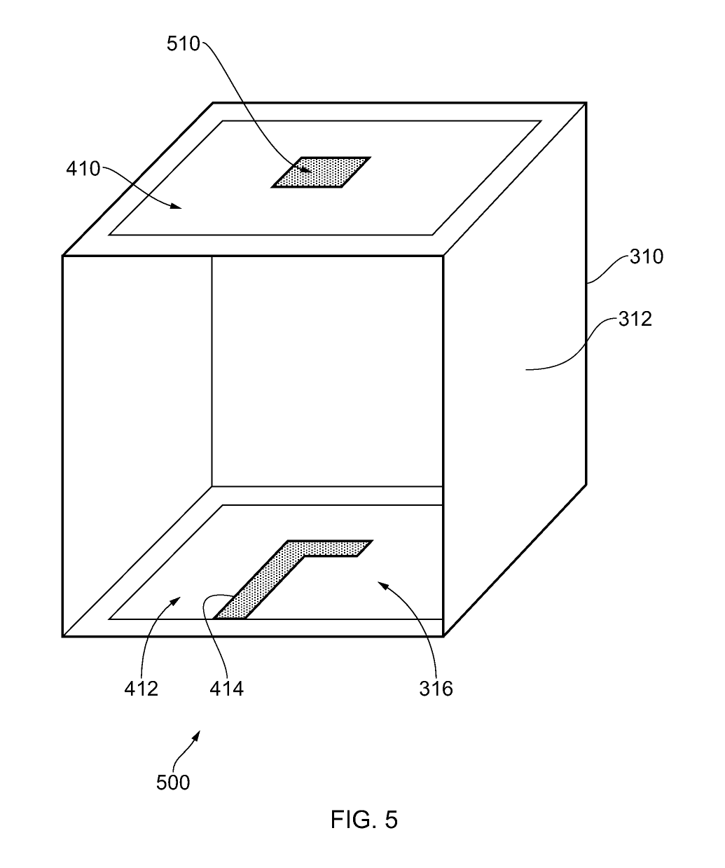

FIG. 5 shows a Filtenna 500 that is a variant of the Filtenna of FIG. 4 in which a patch antenna element 510 has been placed within the window 410 in the top surface of the metallisation 312. This patch element 510 operates in a similar manner to a conventional patch antenna, although in this case, it is fed with signals circulating within the puck 310 (in the case of a transmit filter application), rather than using a conventional feed-line or similar structure. Note that in FIG. 5 the patch element 510 is relatively small compared to its surrounding window 410; in many applications, it may be necessary to reduce the window size such that it is a close fit around the patch element 510. This will ensure that the maximum possible amount of energy is retained within the puck and only the desired amount of energy is radiated via the patch element 510 (i.e. there is little or no unintended ‘leakage’ from the window area around the patch element 510).

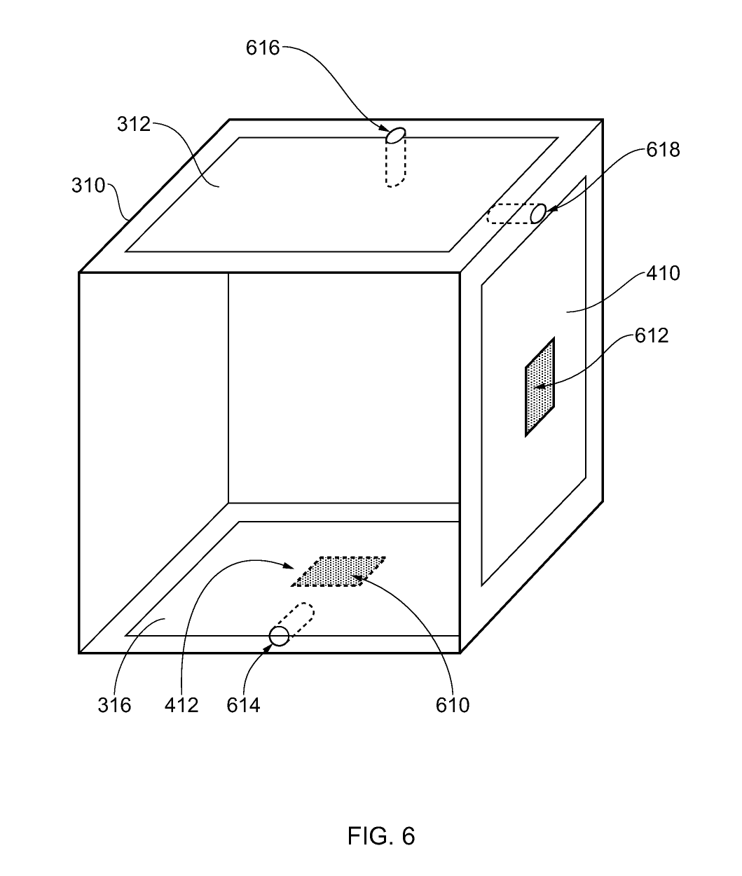

FIG. 6 shows a Filtenna 600 that is a variant of the Filtenna 500 of FIG. 5 and in which patch elements 610 and 612 are used in both the coupling structure 412 and the antenna window 410. In this case, defects need to be introduced into the puck 310 to ensure that multiple modes are coupled to within the puck 310; in the case of FIG. 6, holes 614, 616 and 618 are shown fulfilling this requirement, however a wide range of other defects could also be used.

Although a patch element 612 is shown as part of the antenna structure in FIG. 6, it is also possible for this to be omitted and an ‘open window’ style of antenna structure to be used instead (as featured in FIG. 4).

A further variant of FIG. 6 is that the patch element 610 used as the coupling structure 412 could be replaced by a probe (a needle-like feed conductor intruding into the puck 310) or other predominantly single-mode excitation structure (i.e. a structure requiring the addition of defects in order to allow coupling to multiple modes).

Note that in FIG. 6, the radiating (or receiving) patch 612 is shown as being placed upon an orthogonal side of the puck to the patch element 610 making up the coupling structure 412. This is a requirement of the excitation/coupling arrangement involving the use of defects, in which the antenna window 410 and the coupling structure 412 are shown on orthogonal faces of the puck 310.

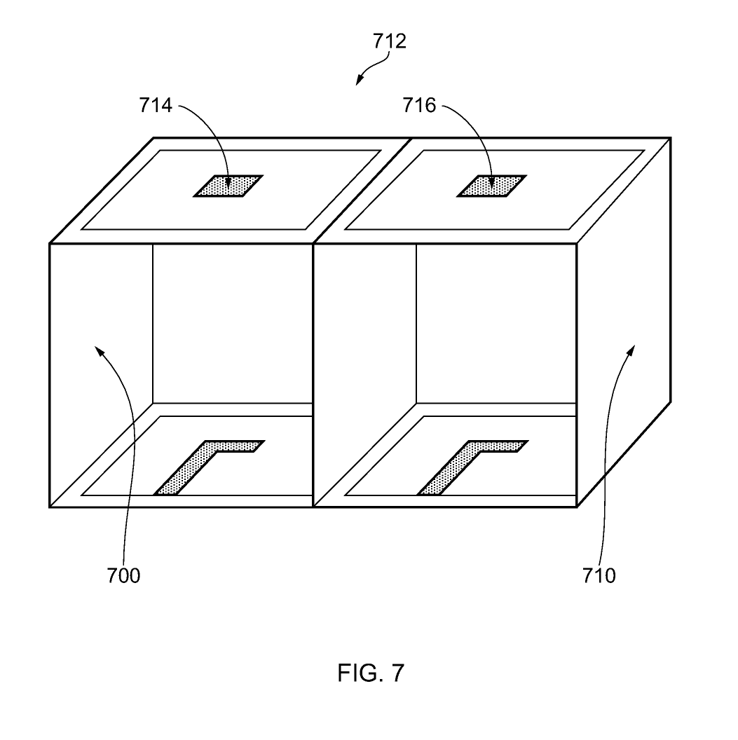

FIG. 7 shows one method by which two Filtennas 700 and 710 can be used to form a duplexer 712. Whilst the two Filtennas 700 and 710 look identical in this schematic figure, the design of the filtering aspect (at least) would be different between the transmit Filtenna 700 and the receive Filtenna 712, due to the different centre frequencies and roll-off characteristics required in each case. Note also that multiple filtering elements are typically cascaded, in both the transmit and receive directions, in order to achieve a given filtering performance level, and only the final stage of the transmit filter line-up and the first stage of the receive filter line-up are shown in this figure.

In a typical antenna system, for example, an active antenna, a single radiating element would be used; this is largely for reasons of size, since the use of separate transmit and receive elements (together with polarisation diversity, which is typically employed in such systems), would result in a doubling of the size of the overall antenna system. This would be unacceptable in most applications, notably: cellular infrastructure. In the case of the system shown in FIG. 7, however, the use of a dielectrically-loaded system, with a high dielectric constant, results in very small Filtennas and these can easily be accommodated side-by-side (or separately) within the dimensions of a current infrastructure antenna. The arrangement is therefore entirely feasible in, for example, cellular infrastructure applications.

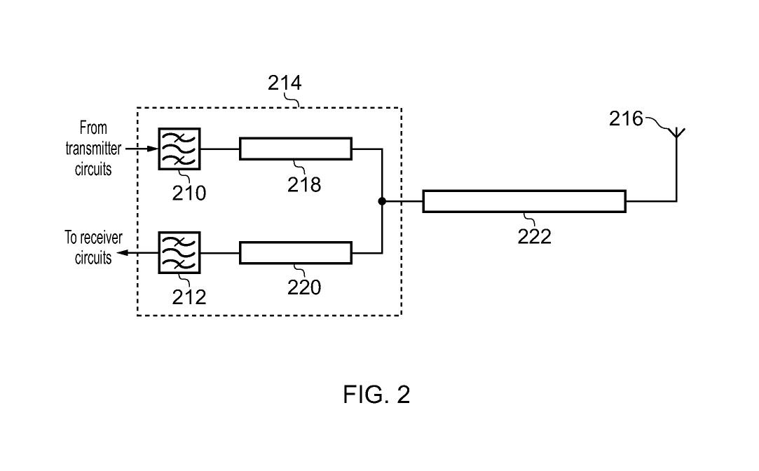

The ‘duplexing’ function of the system does not require a physical connection between the transmit and receive portions of the duplexer (such a connection is shown in FIG. 2), since the two halves of the duplexer are operating independently. There will exist a high degree of isolation between the transit and receive antenna elements 714 and 716, by virtue of their physical placement, side-by-side (i.e. each is placed in a null in the other's antenna radiation pattern). This isolation will not be perfect, however, and there will also typically be some degree of reflection from nearby structures, both leading to some of the transmit signal energy being received by the receive antenna 716. The amount of such energy will, however, be much smaller than in a traditional duplexer, in which the transmit and receive filters are connected directly to one another (as shown in FIG. 2). The specifications of the filtering in both the transmit Filtenna 700 and the receive Filtenna 710 could therefore be relaxed in the implementation shown in FIG. 7, typically leading to a smaller and cheaper system (e.g. requiring only a single filtering element in each of the transmit and receive arms of the system, rather than two or more, in cascade, as is often the case with present multi-mode solutions—and, of course, many more elements for single-mode filters).

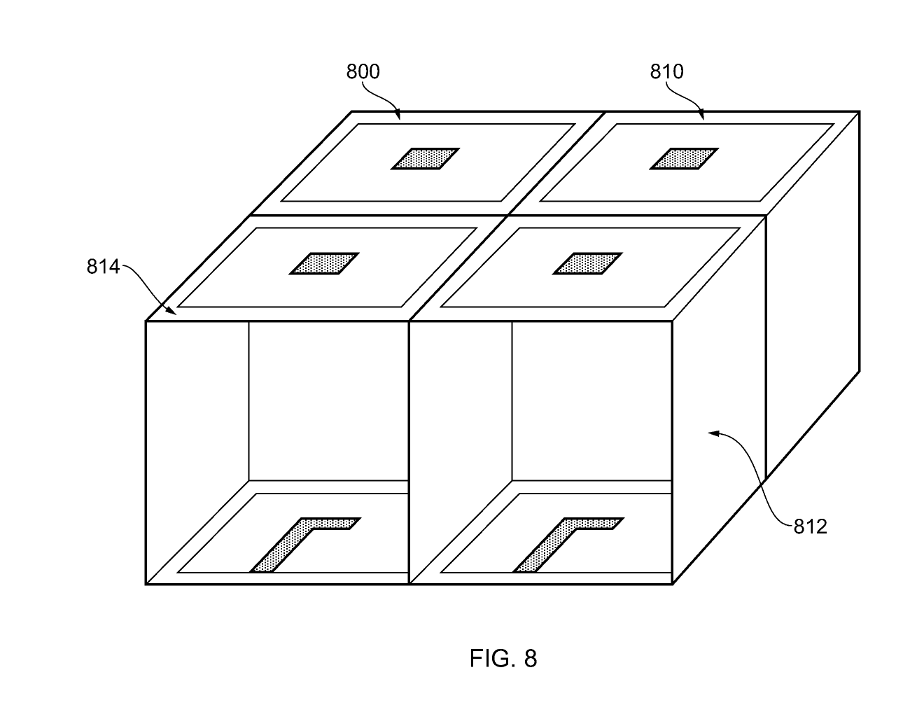

Dual-polarisation, within a single Filtenna, could be provided by means of a suitable feed structure design (or the use of two, orthogonal, feed structures). Likewise, it could also be provided, within a still small footprint, utilising four Filtennas 800, 810, 812 and 814, as shown in FIG. 8. Each of these Filtennas will act independently and be connected to its own transmitter or receiver circuits (as appropriate), possibly via additional (multi-mode) filtering elements, as required to meet a given specification. Each Filtenna is provided with an appropriate feed and antenna structure (for example, antenna shape) to ensure that it generates the correct polarisation for the transmit and/or receive signals which it is required to process. For example, a feed structure for a first polarisation in a first Filtenna may be placed perpendicular to a feed structure for a second polarisation in a second Filtenna. Alternatively (or in addition) a feed structure for a first polarisation in a first Filtenna may be designed to excite a first mode (the X-mode, for example) and a feed structure for a second polarisation in a second Filtenna may be designed to excite a second, orthogonal, mode (the Y-mode, for example), These modes then couple to the antenna structure, which is designed appropriately to couple to such modes, in a first and a second orthogonal directions, respectively, thereby generating a dual-polarisation, dual-Filtenna, structure. To create a full duplexer design, therefore requires two of these dual-Filtenna structures (i.e. a total of four Filtennas), as shown in FIG. 8. Again, here, it is the small size of the dielectric Filtennas which makes this a realistic configuration, in a cellular infrastructure application (for example).

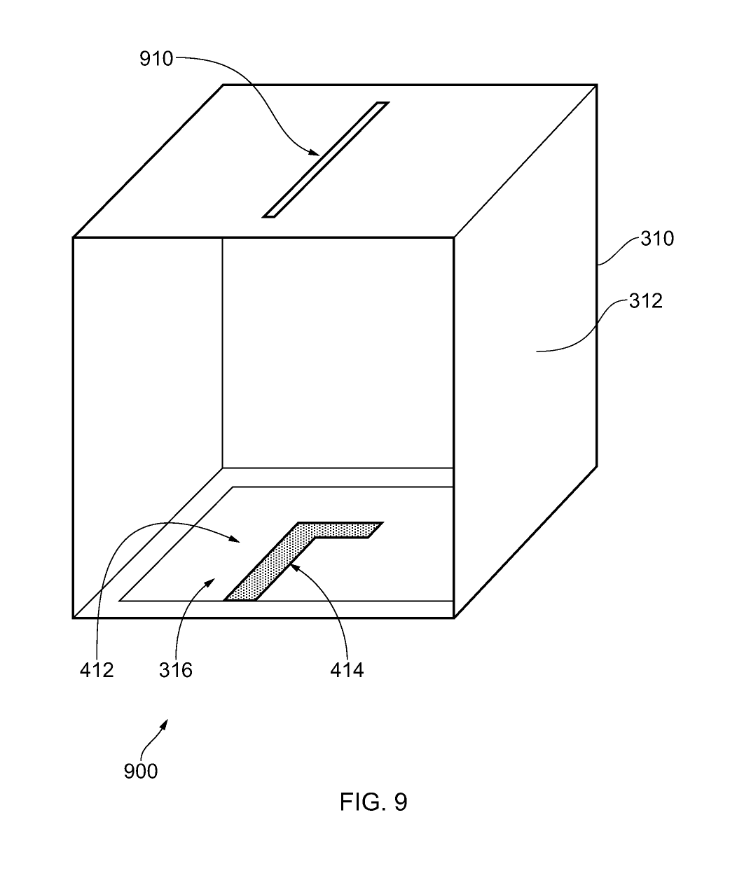

FIG. 9 shows a Filtenna 900 that is a variant of the Filtenna 400 of FIG. 4. However in the case of Filtenna 900 a slot 910 in the metallisation 312 is used in place of the radiating window 410 shown in FIG. 4. In the case of FIG. 9, the slot 910 is shown extending parallel to two of the edges of the puck 310, however this need not be the case. The dimensions of the slot 910 will determine the amount of energy radiated and also the resonator's ability to operate successfully as a resonator—if the slot 910 is very large (as in FIG. 4), then the resonator will have a poor Q, since much of the energy will radiate into the outside world; if the slot 910 is very small, then very little energy will radiate and the system will have good filtering properties, but act as a poor antenna. In between these two extremes, there will be an acceptable compromise for most applications.

The use of a slot 910, if it is sufficiently narrow, will result in a linearly polarised signal emanating from the slot 910; this arrangement is advantageous for some applications (e.g. the use of vertical polarisation where the receive antenna for the transmission is likely also to be vertically polarised).

The orientation of the slot 910 will largely determine which mode dominates the radiation from the Filtenna 900. For example, if the slot 910 is aligned with the X-mode, then the Filtenna 900 will largely radiate X-mode energy, with the other modes remaining within the puck.

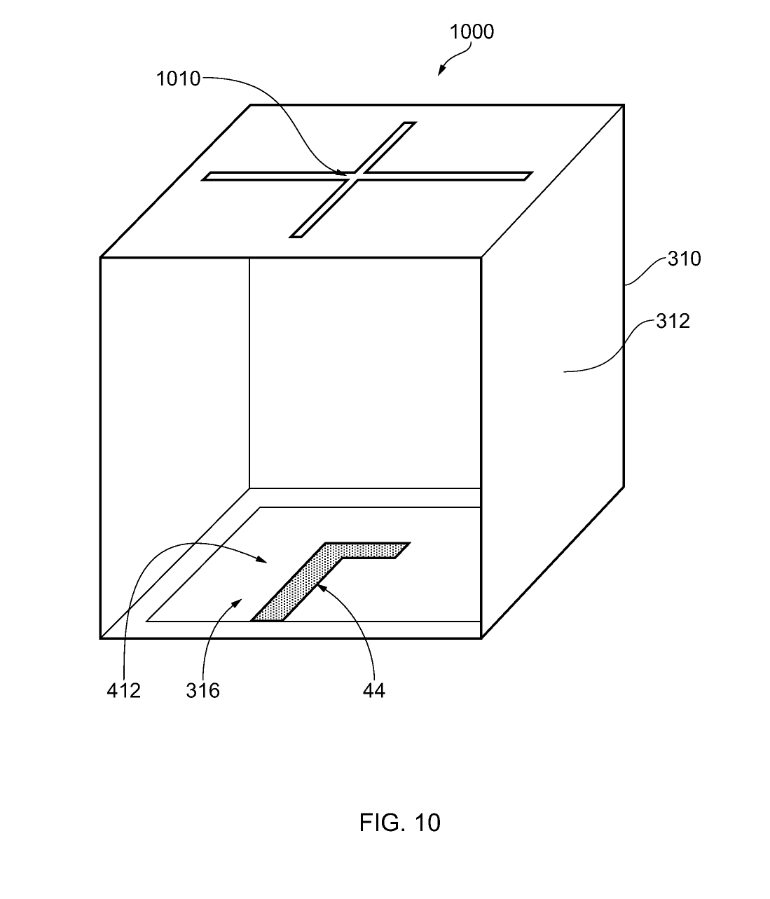

FIG. 10 shows a Filtenna 1000 that is a variant of the Filtenna 900, in which the antenna slot 1010 is cruciform. In this case, with the alignment shown, two modes will radiate from the puck 310 (the X and Y modes), each linearly polarised. Thus the Filtenna 1000 has now become a cross-polar antenna and this is the form of antenna most commonly used in cellular infrastructure applications and consequently is a very useful configuration for the Filtenna.

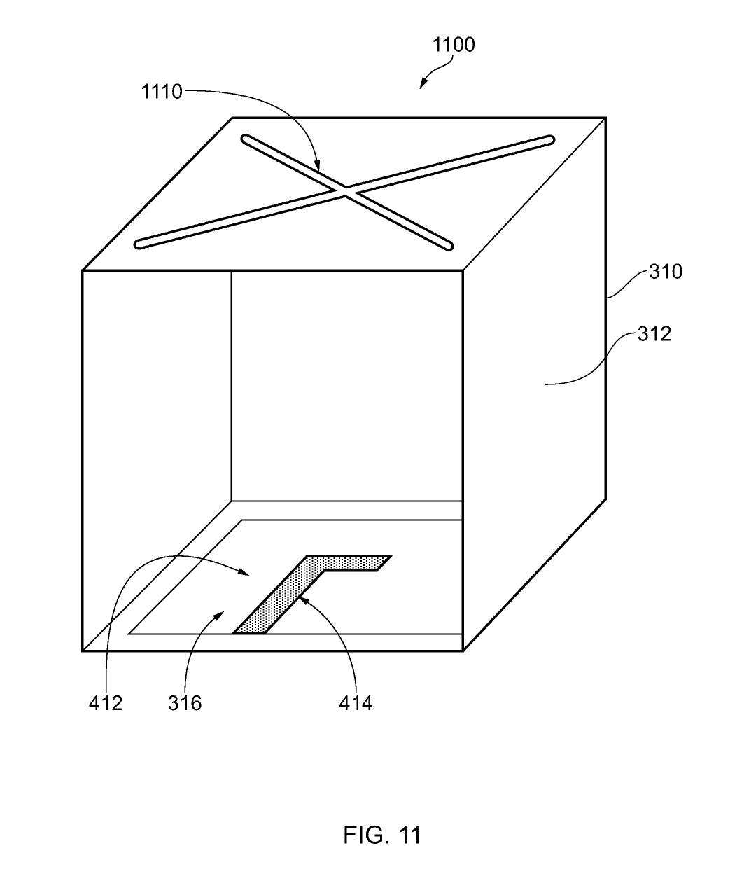

FIG. 11 shows a Filtenna 1100 that is a variant of the Filtenna 1000, in which the cruciform radiating aperture 1110 has a different orientation: in this case, the ends of its arms are aligned with the vertices of the face upon which it is placed. This system will still radiate in two polarisations, however it will receive its energy from multiple modes within the puck 310.

It will be readily understood that the duplexer arrangements shown in FIG. 7 and FIG. 8 could also be employed with the radiating slot structures shown in FIG. 9, FIG. 10 and FIG. 11.

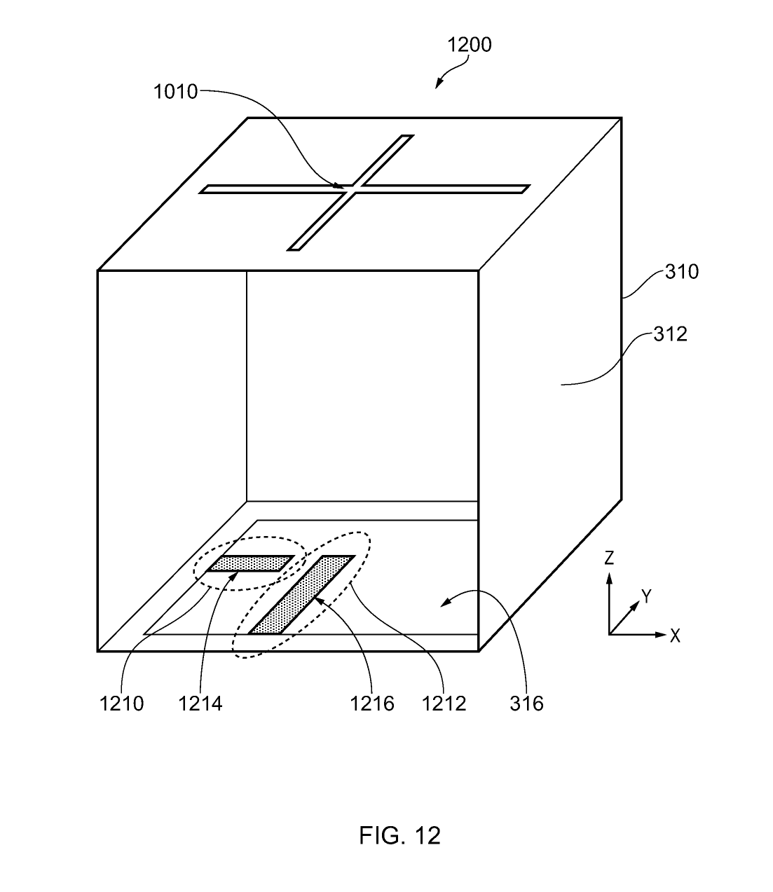

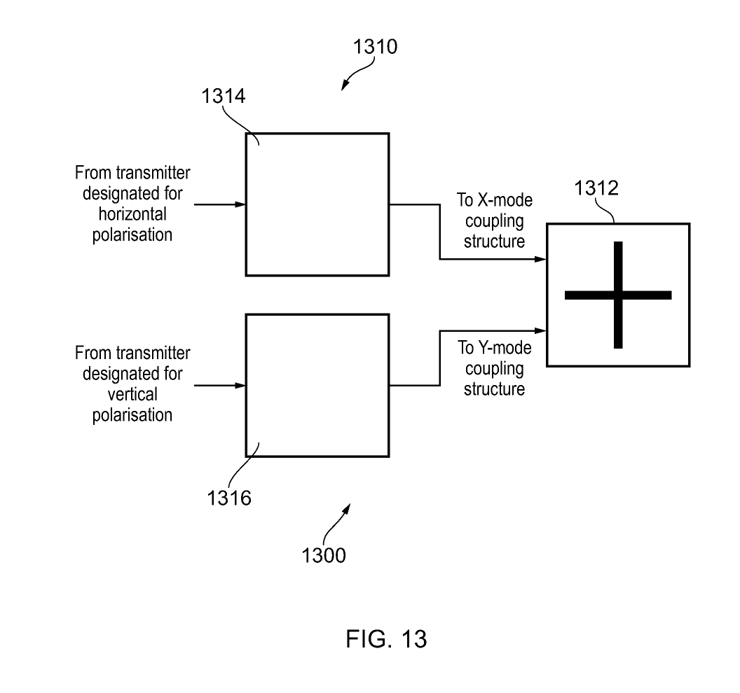

FIG. 12 shows a Filtenna 1200 which is a variant of the Filtenna 1000 of FIG. 10 and in which two separate coupling structures 1210 and 1212 are used to feed the modes which will ultimately be radiated as two separate polarisations. Here, the coupling structures 1210 and 1212 are shown in a simple form, each being depicted as a straight track 1214 and 1216 on the bottom surface of the puck 310. In practice, the coupling structures 1210 and 1212 may be more complex than this. The use of separate coupling structures 1210 and 1212 allows the modes to be addressed individually and thereby operate from, for example, separate transmitters (or be coupled to separate receivers). A true polarisation-diversity system on either transmit or receive can therefore be created, as is shown (in the case of a transmit example) in FIG. 13.

In the case of FIG. 12, the Filtenna 1200 is still a multi-mode resonator, since two separate modes (X and Y, in this example) are excited and exist simultaneously (and orthogonally) in the puck 310. These resonant modes will also have a filtering function and can be cascaded with other multi-mode (or single-mode) filters to provide an improved roll-off response. Note that it would be possible to allow one polarisation to make use of, say, the X and Z modes, thereby improving its filter roll-off performance, with the other polarisation only utilising the Y mode. Whilst this would not be useful in, say, meeting a given emissions specification mandated by the European Telecommunications Standards Institute (ETSI), it could be utilised ‘for free’ (i.e. requiring no additional components or space) to improve the system's performance, in one polarisation, over and above that envisaged by ETSI.

FIG. 13 shows how two (in this example) transmit paths 1300 and 1310 can be connected to a single dual-polarisation Filtenna 1312 (like the one shown in FIG. 12), via separate multi-mode filters 1314 and 1316 (to improve the roll-off response, as discussed above). This type of connection is typically used in transmit-diversity applications, in which separate transmitters fed with separate signals are transmitted, simultaneously, from different polarisations using the same antenna. Likewise, of course, if the transmitter subsystems (the connections to which are shown on the left-hand side of FIG. 13) were replaced by receiver subsystems, then a receive-diversity system would be obtained. Finally, if the two multi-mode filters shown in FIG. 13 were replaced by duplex filters (either single or multi-mode), then a dual-mode transmit and receive diversity system would be created. Note that in this case, the bandwidth of the Filtenna would need to be sufficiently wide to pass both the transmit and receive frequency bands.

Note that combining the ideas shown in FIG. 8 and FIG. 12 would result in a smaller dual-polarisation duplexer. Only two Filtennas would now be required, since each would be a dual-polarisation subsystem, with the two structures being placed side-by side, or in relatively close proximity, in a similar manner to that shown in FIG. 7.

1. A combined filter and antenna structure comprising a multi-mode cavity filter and an antenna, wherein:
the filter comprises:
a dielectric body provided with a conductive covering; and
an interface arranged to exchange energy between a standing wave in the body
and a current conveyed external to the body; and
the antenna is arranged to exchange energy between a travelling wave outside the body and a standing wave inside the body and the antenna comprises:
a first window provided in the covering.

2. The structure of claim 1, wherein the interface comprises a second window provided in the covering and a contact of conductive material connected to the body in the second window.

3. The structure of claim 2, wherein the contact is a patch of conductive material provided on the body in the second window.

4. The structure of claim 3, wherein the patch extends to an edge of the second window and is electrically connected to the covering.

5. The structure of claim 2, wherein the contact is a conductive probe penetrating into the body in the second window.

6. The structure of claim 1, wherein the first window is a straight slot in the covering.

7. The structure of claim 6, wherein the slot is parallel or perpendicular to a current flow that corresponds to a standing wave that will be established in the body when the structure is in use.

8. The structure of claim 1, wherein the first window is cruciform in the manner of first and second intersecting straight slots.

9. The structure of claim 8, wherein the first slot runs perpendicular to the second slot.

10. The structure of claim 8, wherein the first and second slots are parallel with, respectively a first standing wave and a second standing wave that will be established in the body when the structure is in use.

11. The structure of claim 1, wherein the interface comprises a second window provided in the covering and a contact of conductive material connected to the body in the second window.

12. The structure of claim 10, wherein the interface comprises a second window provided in the covering, a first conductive track on the body in the second window and a second conductive track on the body in the second window and the first and second tracks are configured to preferentially couple to the first and second standing waves, respectively.

13. The structure of claim 1, wherein the antenna further comprises an island of conductive material on the body in the first window.

14. The structure of claim 13, wherein the interface comprises a second window provided in the covering and a contact of conductive material connected to the body in the second window and the antenna further comprises a ground plane separated from the island and the ground plane is positioned to at least partially cover the second window.

15. The structure of claim 1, wherein the covering is a coating on the body.

16. The structure of claim 2, wherein the first and second windows are parallel with one another.

17. A duplexer comprising two combined filter and antenna structures, wherein each combined filter and antenna structure comprises:
a multi-mode cavity filter and an antenna, wherein:
the filter comprises:
a dielectric body provided with a conductive covering; and
an interface arranged to exchange energy between a standing wave in
the body and a current conveyed external to the body; and
the antenna is arranged to exchange energy between a travelling wave outside the body and a standing wave inside the body and the antenna comprises:
a first window provided in the covering.
